(19) United States
(12) Patent Application Publication
(10) Pub. No.: US 2011/0161446 A1
(43) Pub. Date: Jun. 30, 2011

(54) Apparatus and method for synchronizing data between instant messaging clients in communication system

(75) Inventor: Seong-Eun Kim, Seongnam-si (KR)

(73) Assignee: Samsung Electronics Co., Ltd., Suwon-si (KR)

(21) Appl. No.: 12/930,011

(22) Filed: Dec. 23, 2010

(30) Foreign Application Priority Data
Dec. 24, 2009 (KR) 10-2009-0131154

(51) Int. Cl. G06F 15/16

(52) U.S. Cl. 709/206

(57) ABSTRACT

An apparatus and a method for efficiently synchronizing data between Instant Messaging (IM) clients in a communication system. A method for requesting to synchronize data of a terminal which uses an IM service includes when data synchronization with another terminal is requested during IM communication with the other terminal, generating Synchronization Markup Language (SyncML) request data to request to synchronize a corresponding data, inserting the generated SyncML request data to an IM message, and sending the IM message to the other terminal.

### CROSS-REFERENCE TO RELATED APPLICATION(S) AND CLAIM OF PRIORITY

The present application claims the benefit under 35 U.S.C. §119(a) to a Korean patent application filed in the Korean Intellectual Property Office on Dec. 24, 2009, and assigned Serial No. 2009-0131154, the entire disclosure of which is hereby incorporated by reference.

### TECHNICAL FIELD OF THE INVENTION

The present invention relates generally to data synchronization. More particularly, the present invention relates to an apparatus and a method for efficiently synchronizing data between Instant Messaging (IM) clients.

### BACKGROUND OF THE INVENTION

An Instant Messaging (IM) service is a mobile messaging service for exchanging messages between mobile users based on Internet in real time. Thanks to the real-time communication, the IM service is prevalently adopted and widely used over the Internet.

Recently, users of the real-time messaging service through the IM service are demanding not only the simple message exchange but also their personal data sharing. To respond to this, an efficient and simple method is required.

In the conventional IM service, the user sends a text or a file to share his/her data with the other user. The user receiving the text or the file may need to perform an additional input or storing so as to store the received text or file to its database.

With regard to this, what is a needed is a method for efficiently sharing the data between the users of the IM service.

### SUMMARY OF THE INVENTION

To address the above-discussed deficiencies of the prior art, it is a primary aspect of the present invention to provide an apparatus and a method for efficiently synchronizing data between IM clients in a communication system.

Another aspect of the present invention is to provide an apparatus and a method for efficiently synchronizing data between IM clients using Synchronization Markup Language (SyncML) data in a communication system.

Yet another aspect of the present invention is to provide an apparatus and a method for automatically storing data to synchronize to a database by inserting SyncML data to IM messages sent and received between IM clients in a communication system, without additional input of a user or additional storing.

According to one aspect of the present invention, a method for requesting to synchronize data of a terminal which uses an Instant Messaging (IM) service includes when data synchronization with another terminal is requested during IM communication with the other terminal, generating SyncML request data to request to synchronize a corresponding data, inserting the generated SyncML request data to an IM message, and sending the IM message to the other terminal.

According to another aspect of the present invention, a method for processing synchronization request of a terminal which uses an IM service includes during IM communication with another terminal, receiving from the other terminal an IM message which includes Synchronization Markup Language (SyncML) request data to request to synchronize data, extracting the SyncML request data from the received IM message, and processing the corresponding data synchronization based on the extracted SyncML request data.

According to yet another aspect of the present invention, an apparatus for requesting to synchronize data of a terminal which uses an IM service includes a SyncML framework for, when data synchronization with other terminal is used during IM communication with the other terminal, generating SyncML request data to request to synchronize a corresponding data. The apparatus also includes an IM framework for inserting the generated SyncML request data to an IM message and sending the IM message to the other terminal.

According to still another aspect of the present invention, an apparatus for processing synchronization request of a terminal which uses an IM service includes an IM framework for, during IM communication with other terminal, receiving from the other terminal an IM message which includes Synchronization Markup Language (SyncML) request data to request to synchronize data, and extracting the SyncML request data from the received IM message. The apparatus also includes a SyncML framework for processing the corresponding data synchronization based on the extracted SyncML request data.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a communication system according to an embodiment of the present invention;

FIG. 2 illustrates an IM message used to synchronize data between IM clients using SyncML data in the communication system according to an embodiment of the present invention;

FIG. 3 is a signal flow diagram of a method for synchronizing the data between the IM clients using the SyncML data in the communication system according to an embodiment of the present invention;

FIG. 4 is a block diagram of the IM client for synchronizing the data between the IM clients using the SyncML data in the communication system according to an embodiment of the present invention;

FIG. 5 is a flowchart of an operating method of a sender IM client for synchronizing the data between the IM clients using the SyncML data in the communication system according to an embodiment of the present invention; and

FIG. 6 is a flowchart of an operating method of a receiver IM client for synchronizing the data between the IM clients using the SyncML data in the communication system according to an embodiment of the present invention.

Throughout the drawings, like reference numerals will be understood to refer to like parts, components and structures.

### DETAILED DESCRIPTION OF THE INVENTION

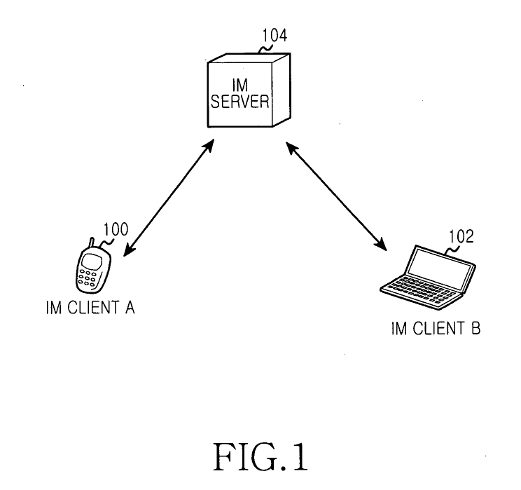

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged communication system.

Exemplary embodiments of the present invention provide a method for synchronizing data between Instant Messaging (IM) clients using Synchronization Markup Language (SyncML) data in a communication system. The data includes information sharable between the IM clients, such as address book, schedule, e-mail, and memo. Each individual IM client includes a database for storing and managing the data.

Prior to explanations of the present invention, the SyncML is described.

The SyncML, which is a Markup Language based on eXtensible Markup Language (XML), is a data format for delivering data between different devices to synchronize data. Herein, the synchronization makes data stored to the different devices consistent. The device encodes and sends a message including the data to synchronize and information of a synchronization instruction according to a predefined SyncML standard. The device receiving the message decodes the corresponding message according to the same SyncML standard and processes the corresponding data according to the corresponding synchronization instruction. The present invention relates to a method for using the SyncML to synchronize the data between the IM clients. More specifically, the present invention relates to a method for synchronizing the data by inserting the SyncML data into the IM messages exchanged between the IM clients, without additional input of the user or additional storing.

FIG. 1 depicts a communication system according to an embodiment of the present invention.

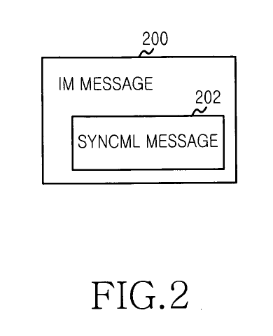

The communication system of FIG. 1 includes an IM server 104 and a plurality of IM clients, for example, an IM client A 100 and an IM client B 102. The IM server 104 processes connection control, status management, IM message delivery, and so forth. The IM clients 100 and 102 provide the mobile message service (i.e., the IM service) to users through the IM connection. The IM clients 100 and 102 each include a database for storing and managing data. When the data synchronization in the database is requested during the general IM communication, the data synchronization may be carried out using the IM message generating at the corresponding time. The IM message used to synchronize the data between the IM clients 100 and 102 is generated by additionally inserting a SyncML message into the IM message used in the general IM communication, which shall be elucidated by referring to FIG. 2.

FIG. 2 depicts the IM message used to synchronize the data between the IM clients using the SyncML data in the communication system according to an embodiment of the present invention.

The IM message 200 used to synchronize the data between the IM clients of FIG. 2 additionally inserts a SyncML message 202 into the IM message used in the general IM communication. Herein, the SyncML message 202 includes SyncML start data, SyncML request data, SyncML end data, or SyncML response data.

The SyncML start data is SyncML data for informing of the transmission start of the SyncML request data, and the SyncML end data is SyncML data for informing of the transmission end of the SyncML request data. The SyncML request data, which is SyncML data for requesting the data synchronization, may include information relating to the data to synchronize and a specific instruction (for example, add, delete, replace, update, and get) for the corresponding data synchronization. The information of the data to synchronize may include the data itself or index information of the corresponding data. Herein, when it is impossible to generate the SyncML request data with one data, the SyncML request data may include a plurality of data. The SyncML response data is SyncML data for responding to the SyncML start data, the SyncML request data, or the SyncML end data, and may include process result information (e.g., success/failure or data itself).

Although it is not illustrated here, the SyncML message 202 inserted to the IM message 200 is split to a header and a body. The header may include information such as session identifier (ID), message ID, target Uniform Resource Identifier (URI), and source UI, and the body may include at least one of the information relating to the data to synchronize, the specific instruction to synchronize the corresponding data, and the process result information.

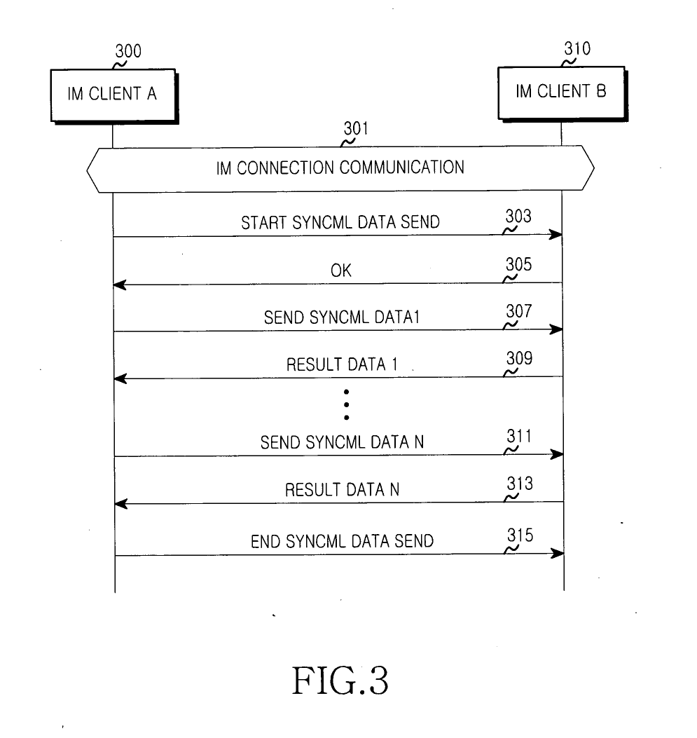

FIG. 3 is a signal flow diagram of a method for synchronizing the data between the IM clients using the SyncML data in the communication system according to an embodiment of the present invention.

An IM client A 300 and an IM client B 310 perform the general IM communication by exchanging IM messages through the IM connection in step 301.

In the process of the general IM communication, to synchronize the data with the IM client B 310, the IM client A 300 generates the SyncML start data informing of the transmission start of the SyncML request data and sends an IM message including the generated SyncML start data to the IM client B 310 in step 303.

The IM client B 310 receiving the IM message including the SyncML start data generates SyncML response data including OK response information or negative response information according to whether it is possible to respond to the SyncML start data with the OK, and sends an IM message including the generated SyncML response data to the IM client A 300 in step 305.

When the SyncML response data includes the OK response information, the IM client A 300 receiving the IM message including the SyncML response data generates SyncML request data1 and sends an IM message including the generated SyncML request data1 to the IM client B 310 in step 307. Herein, the SyncML request data may include the information relating to the data to synchronize and a specific instruction (for example, add, delete, replace, update, and get) for the corresponding data synchronization. The information of the data to synchronize may include the data itself or the index information of the corresponding data.

The IM client B 310 receiving the IM message including the SyncML request data1 processes the corresponding instruction for the data to synchronize based on the SyncML request data, generates SyncML response data1 including the process result information (e.g., success/failure or data itself), and sends an IM message including the generated SyncML response data1 to the IM client A 300 in step 309.

Herein, when it is impossible to generate the SyncML request data with one data, the SyncML request data may include a plurality of (e.g., n-ary) data. Accordingly, the IM client A 300 and the IM client B 310 may exchange the plurality of (e.g., n-ary) SyncML request data and SyncML response data in steps 311 and 313.

When the transmission of every SyncML request data is completed, the IM client A 300 generates SyncML end data informing of the transmission end of the SyncML request data, and sends an IM message including the generated SyncML end data to the IM client B 310 in step 315.

Next, the IM client A 300 and the IM client B 310 finish the data synchronization using the SyncML data and resume the general IM communication.

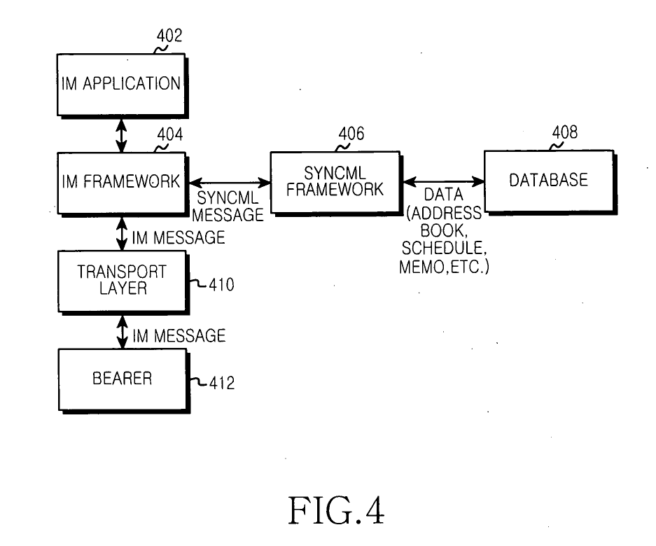

FIG. 4 is a block diagram of the IM client for synchronizing the data between the IM clients using the SyncML data in the communication system according to an embodiment of the present invention.

The IM client of FIG. 4 includes an IM application 402, an IM framework 404, a SyncML framework 406, a database 408, a transport layer 410, and a bearer 412.

The IM application 402, which is a mobile messenger application, provides the user with the mobile messaging service (i.e., the IM service). Herein, the mobile messaging service is provided by exchanging the IM messages between the IM clients through the IM connection. For doing so, the IM application 402 provides the IM framework 404 with information input or selected directly by the user as the transmit data, and controls the IM framework 404 to generate the IM message including the transmit data. The IM application 402 controls the IM framework 404 to send the receive data from the receiver user to itself so that the user may confirm the receive data provided from the IM framework 404. In addition, when the data synchronization with the other user is requested according to a user's menu manipulation during the general IM communication, the IM application 402 provides the IM framework 404 with information (e.g., index) relating to the data to synchronize, and controls the IM framework 404 to acquire the SyncML message from the SyncML framework 406 based on the information of the data to synchronize and to include the SyncML message to the IM message generated at the corresponding time.

The IM framework 404 generates and encodes the IM message based on the transmit data fed from the IM application 402 and then provides the IM message to the transport layer 410, and decodes and processes the IM message input from the transport layer 410 and then provides the IM message to the IM application 402. In the IM message generation, when the IM application 402 provides the information (e.g., the index) of the data requested to synchronize, the IM framework 404 forwards the information of the data to synchronize to the SyncML framework 406. Until the synchronization of the corresponding data is completed, the IM framework 404, as generating the IM message, obtains the SyncML message to synchronize the corresponding data from the SyncML framework 406 and includes the SyncML message to the IM message generated at the corresponding time. When processing the IM message from the transport layer 410, the IM framework 404 extracts the SyncML message from the IM message and outputs the SyncML message to the SyncML framework 406.

Until the synchronization of the corresponding data is completed, the SyncML framework 406 generates, encodes and provides the SyncML message to the IM framework 404, and decodes and processes the SyncML message fed from the IM framework 404.

Herein, in the sender IM client, the SyncML framework 406 receives the information (e.g., the index) of the data to synchronize from the IM framework 404, generates, encodes, and provides to the IM framework 404 the SyncML start data, the SyncML request data, or the SyncML end data based on the received information until the corresponding data synchronization is completed, and receives, decodes, and processes the SyncML response data from the IM framework 404. Herein, the SyncML request data may include the information relating to the data to synchronize and the specific instruction (for example, add, delete, replace, update, and get) for the corresponding data synchronization. The information of the data to synchronize may include the data itself or the index information of the corresponding data. Herein, when the SyncML request message generation uses the data to synchronize, the SyncML framework 406 may extract the corresponding data from the database 408 and include the data to the SyncML request message. As processing the SyncML response message received in reply to the SyncML request message, when the SyncML response message includes the data to synchronize, the SyncML framework 406 may store the data to synchronize to the database 408.

In the receiver IM client, the SyncML framework 406 decodes and processes the SyncML start data; the SyncML request data, or the SyncML end data received from the IM framework 404 until the corresponding data synchronization is completed, and generates, encodes, and provides the SyncML response data to the IM framework 404. The process on the SyncML request data may add, delete, replace, update, or get the data to synchronize based on the corresponding SyncML request data, which may be carried out in conjunction with the database 408. Herein, the SyncML response data sent in reply to the SyncML request data may include the process result information (e.g., the success/failure or the corresponding data itself) of the corresponding data synchronization.

The database 408 stores and manages the data such as address book, schedule, e-mail, and memo.

The transport layer 410, which is a protocol layer for sending and receiving the IM message, forwards the IM message from the IM framework 404 to the bearer 412 and forwards the IM message from the bearer 412 to the IM framework 404.

The bearer 412, which corresponds to a communication network carrying the IM message, delivers the IM messages between the IM clients.

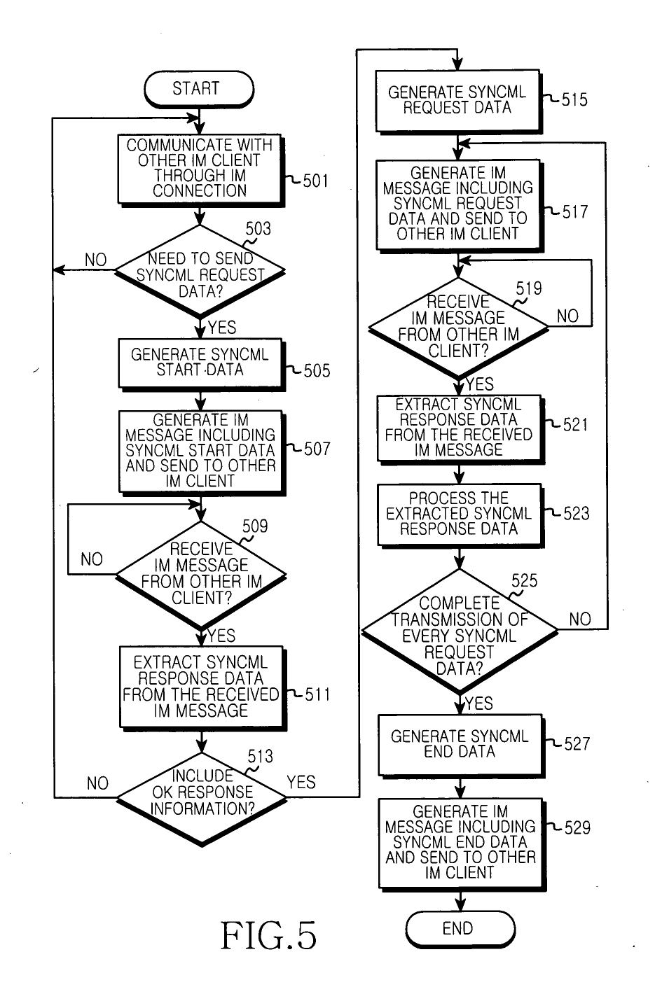

FIG. 5 is a flowchart of an operating method of the sender IM client for synchronizing the data between the IM clients using the SyncML data in the communication system according to an embodiment of the present invention.

In step 501, the sender IM client conducts the general IM communication by exchanging the IM messages with the other IM client through the IM connection.

In step 503, the sender IM client determines whether it is necessary to send the SyncML request data to the other IM client according to the user's request. For example, when the user wants to synchronize the data with the other user, the user may select the data to synchronize by manipulating the menu of the sender IM client, and request to synchronize the selected data. At this time, the sender IM client may determine that the transmission of the SyncML request data is necessary.

Not determining that it is necessary to send the SyncML request data to the other IM client in step 503, the sender IM client goes back to step 501.

By contrast, determining that it is necessary to send the SyncML request data to the other IM client in step 503, the sender IM client generates the SyncML start data informing of the transmission start of the SyncML request data in step 505.

In step 507, the sender IM client generates the IM message including the generated SyncML start data and sends the generated IM message to the other IM client.

In step 509, the sender IM client determines whether an IM message is received from the other IM client.

Upon receiving the IM message from the other IM client in step 509, the sender IM client extracts the SyncML response data from the received IM message in step 511. Herein, the SyncML response data may includes the OK response information or the negative response information in reply to the sent SyncML start data.

In step 513, the sender IM client determines whether the extracted SyncML response data includes the OK response information.

When the extracted SyncML response data includes the negative response information in step 513, the sender IM client returns to step 501. In so doing, the sender IM client may inform the user of the impossible data synchronization with the other user.

By contrast, when the extracted SyncML response data includes the OK response information in step 513, the sender IM client generates the SyncML request data in step 515. Herein, the SyncML request data may include the information relating to the data to synchronize and the specific instruction (for example, add, delete, replace, update, and get) for the corresponding data synchronization. The information of the data to synchronize may include the data itself or the index information of the corresponding data. Herein, when it is impossible to generate the SyncML request data with one data, the SyncML request data may include a plurality of data.

In step 517, the sender IM client generates an IM message including the generated SyncML request data and sends the generated IM message to the other IM client.

In step 519, the sender IM client determines whether an IM message is received from the other IM client.

Upon receiving the IM message from the other IM client in step 519, the sender IM client extracts the SyncML response data from the received IM message in step 521 and processes the extracted SyncML response data in step 523.

For example, when the sender IM client sends the data to synchronize and an additional instruction to add the corresponding data to the other IM client using the SyncML request data, the other IM client may add the corresponding data to its database and send the SyncML response data including the process result information (e.g., the success/failure) to the sender IM client. The sender IM client may confirm the success/failure of the data synchronization based on the process result information.

Likewise, when the sender IM client sends the data to synchronize and a delete/replace/update instruction to delete/replace/update the corresponding data to the other IM client using the SyncML request data, the other IM client may delete/replace/update the corresponding data in its database and send the SyncML response data including the process result information (e.g., the success/failure) to the sender IM client. The sender IM client may confirm the success/failure of the data synchronization based on the process result information.

When the sender IM client sends the data to synchronize and a get instruction to get the corresponding data to the other IM client using the SyncML request data, the other IM client may extract the corresponding data from its database and send the SyncML response data including the extracted data as the process result information to the sender IM client. The sender IM client may store the data acquired by requesting to the other IM client, to its database.

In step 525, the sender IM client examines whether the transmission of every SyncML request data is completed.

When the transmission of every SyncML request data is not completed in step 525, the sender IM client returns to step 517 to repeat the same operation on the remaining SyncML request data.

By contrast, when the transmission of every SyncML request data is completed in step 525, the sender IM client generates the SyncML end data informing of the transmission end of the SyncML request data in step 527.

In step 529, the sender IM client generates an IM message including the generated SyncML end data and sends the generated IM message to the other IM client.

Next, the sender IM client finishes the data synchronization process using the SyncML data and resumes the general IM communication.

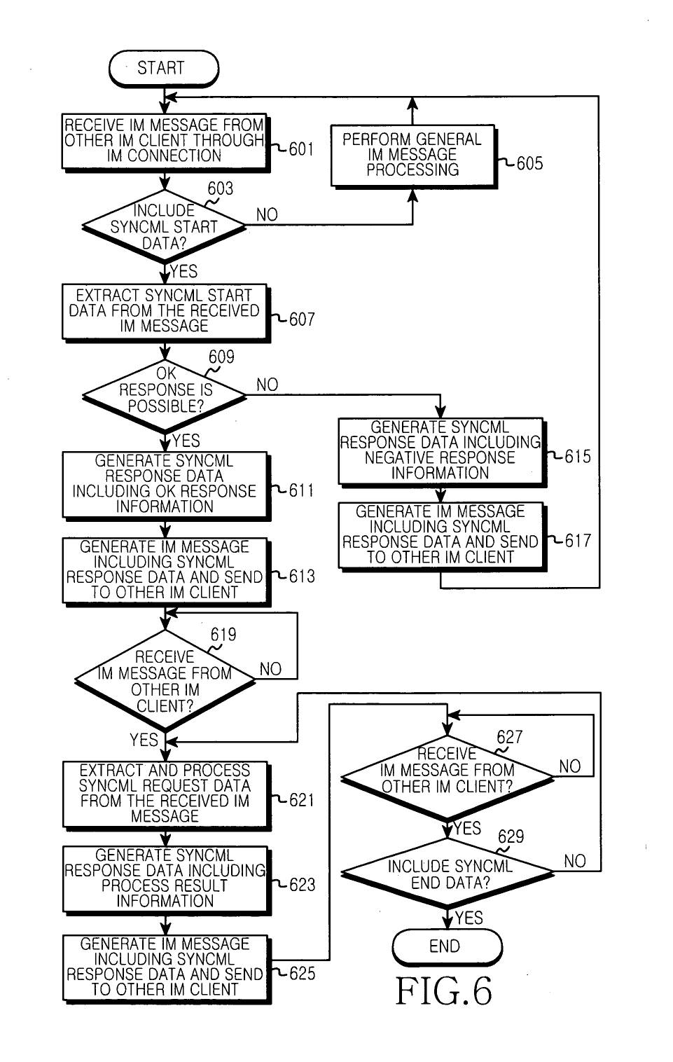

FIG. 6 is a flowchart of an operating method of the receiver IM client for synchronizing the data between the IM clients using the SyncML data in the communication system according to an embodiment of the present invention.

In step 601, the receiver IM client receives the IM message from the other IM client through the IM connection.

In step 603, the receiver IM client determines whether the received IM message includes the SyncML start data informing of the transmission start of the SyncML request data. Herein, whether the received IM message includes the SyncML start data may be determined based on the header information of the received IM message.

When the received IM message does not include the SyncML start data in step 603, the receiver IM client performs the general IM message process on the received IM message in step 605 and then goes back to step 601.

By contrast, when the received IM message includes the SyncML start data in step 603, the receiver IM client extracts the SyncML start data from the received IM message in step 607 and determines whether it is possible to respond with OK to the extracted SyncML start data in step 609.

When it is not possible to respond with OK to the extracted SyncML start data in step 609, the receiver IM client generates SyncML response data including the negative response information in step 615. Next, the receiver IM client generates an IM message including the generated SyncML response data and sends the generated IM message to the other IM client in step 617, and then returns to step 601.

By contrast, when it is possible to respond with OK to the extracted SyncML start data in step 609, the receiver IM client generates SyncML response data including the OK response information in step 611. In step 613, the receiver IM client generates an IM message including the generated SyncML response data and sends the generated IM message to the other IM client.

In step 619, the receiver IM client determines whether an IM message is received from the other IM client.

Upon receiving the IM message from the other IM client in step 619, the receiver IM client extracts and processes the SyncML request data from the received IM message in step 621, and generates SyncML response data including the process result information in step 623. Herein, the SyncML request data may include the information relating to the data to synchronize and the specific instruction (for example, add, delete, replace, update, and get) for the corresponding data synchronization. The information of the data to synchronize may include the data itself or the index information of the corresponding data.

For example, when the other IM client sends the data to synchronize and the additional instruction to add the corresponding data to the receiver IM client using the SyncML request data, the receiver IM client may add the corresponding data to its database and send the SyncML response data including the process result information (e.g., the success/failure) to the other IM client.

Likewise, when the other IM client sends the data to synchronize and the delete/replace/update instruction to delete/replace/update the corresponding data to the receiver IM client using the SyncML request data, the receiver IM client may delete/replace/update the corresponding data in its database and send the SyncML response data including the process result information (e.g., the success/failure) to the other IM client.

When the other IM client sends the data to synchronize and the get instruction to get the corresponding data to the receiver IM client using the SyncML request data, the receiver IM client may extract the corresponding data from its database and send the SyncML response data including the extracted data as the process result information to the other IM client.

In step 625, the receiver IM client generates an IM message including the generated SyncML response data and sends the generated IM message to the other IM client.

In step 627, the receiver IM client determines whether an IM message is received from the other IM client.

Upon receiving the IM message from the other IM client in step 627, the receiver IM client determines whether the received IM message includes the SyncML end data in step 629.

When the received IM message does not include the SyncML end data in step 629, the receiver IM client goes back to step 621.

By contrast, when the received IM message includes the SyncML end data in step 629, the receiver IM client determines that every SyncML request data transmission from the other IM client is completed, finishes the data synchronization process using the SyncML data, and then resumes the general IM communication.

As set forth above, the data is synchronized by inserting the SyncML data into the IM message delivered between the IM clients in the communication system. Therefore, the corresponding data is automatically stored to the database without additional input of the user or additional storing, and the IM clients may efficiently share the data.

Although the present disclosure has been described with exemplary embodiments, various changes and modifications may be suggested to one skilled in the art. It is intended that the present disclosure encompass such changes and modifications as fall within the scope of the appended claims.

What is claimed is:

1. A method for requesting to synchronize data of a terminal which uses an Instant Messaging (IM) service, the method comprising:
when data synchronization with another terminal is requested during IM communication with the other terminal, generating Synchronization Markup Language (SyncML) request data to request to synchronize a corresponding data; and
inserting the generated SyncML request data to an IM message and sending the IM message to the other terminal.

2. The method of claim 1, further comprising:
generating SyncML start data to inform of a transmission start of the SyncML request data; and
inserting the generated SyncML start data to the IM message and sending the IM message to the other terminal.

3. The method of claim 2, further comprising:
receiving an IM message which comprises SyncML response data corresponding to the SyncML start data, from the other terminal;
extracting the SyncML response data from the IM message; and
determining whether the extracted SyncML response data comprises positive response information for the SyncML start data.

4. The method of claim 1, wherein the SyncML request data comprises at least one of information relating to the data to synchronize and an instruction to synchronize the corresponding data.

5. The method of claim 4, further comprising:
accessing a database and obtaining the information relating to the data to synchronize.

6. The method of claim 1, further comprising:
receiving an IM message which comprises SyncML response data corresponding to the SyncML request data, from the other terminal;
extracting the SyncML response data from the IM message; and
obtaining process result information of the corresponding data synchronization based on the extracted SyncML response data.

7. The method of claim 1, further comprising:
generating SyncML end data to inform of a transmission end of the SyncML request data; and
inserting the generated SyncML end data to the IM message and sending the IM message to the other terminal.

8. A method for processing a synchronization request of a terminal which uses an Instant Messaging (IM) service, the method comprising:
during IM communication with another terminal, receiving from the other terminal an IM message which comprises Synchronization Markup Language (SyncML) request data to request to synchronize data;
extracting the SyncML request data from the received IM message; and
processing the corresponding data synchronization based on the extracted SyncML request data.

9. The method of claim 8, further comprising:
generating SyncML response data which comprises process result information of the corresponding data synchronization; and
inserting the generated SyncML response data to an IM message and sending the IM message to the other terminal.

10. The method of claim 8, further comprising:
receiving from the other terminal an IM message which comprises SyncML start data to inform of a transmission start of the SyncML request data;
extracting the SyncML start data from the received IM message;
based on the extracted SyncML start data, determining whether it is possible to synchronize the corresponding data;
generating SyncML response data which comprises information of whether the corresponding data synchronization is possible; and
inserting the generated SyncML response data to an IM message and sending the IM message to the other terminal.

11. The method of claim 8, wherein the SyncML request data comprises at least one of information relating to the data to synchronize and an instruction to synchronize the corresponding data.

12. The method of claim 8, wherein the processing of the corresponding data synchronization is performed in conjunction with a database.

13. The method of claim 8, further comprising:
receiving from the other terminal an IM message which comprises SyncML end data to inform of a transmission end of the SyncML request data; and
extracting the SyncML end data from the received IM message.

14. An apparatus for requesting to synchronize data of a terminal which uses an Instant Messaging (IM) service, the apparatus comprising:
a Synchronization Markup Language (SyncML) framework configured, when data synchronization with another terminal is requested during IM communication with the other terminal, to generate SyncML request data to request to synchronize a corresponding data; and
an IM framework configured to insert the generated SyncML request data to an IM message and send the IM message to the other terminal.

15. The apparatus of claim 14, wherein the SyncML framework is configured to generate SyncML start data to inform of a transmission start of the SyncML request data, and
the IM framework is configured to insert the generated SyncML start data to the IM message and send the IM message to the other terminal.

16. The apparatus of claim 15, wherein the IM framework is configured to receive an IM message which comprises SyncML response data corresponding to the SyncML start data, from the other terminal, and extract the SyncML response data from the IM message, and
the SyncML framework is configured to determine whether the extracted SyncML response data comprises positive response information for the SyncML start data.

17. The apparatus of claim 14, wherein the SyncML request data comprises at least one of information relating to the data to synchronize and an instruction to synchronize the corresponding data.

18. The apparatus of claim 17, wherein the SyncML framework is configured to obtain the information relating to the data to synchronize by accessing a database.

19. The apparatus of claim 14, wherein the IM framework is configured to receive an IM message which comprises SyncML response data corresponding to the SyncML request data, from the other terminal, and extract the SyncML response data from the IM message, and
the SyncML framework is configured to obtain process result information of the corresponding data synchronization based on the extracted SyncML response data.

20. The apparatus of claim 14, wherein the SyncML framework is configured to generate SyncML end data to inform of a transmission end of the SyncML request data, and
the IM framework is configured to insert the generated SyncML end data to the IM message and send the IM message to the other terminal.

21. An apparatus for processing synchronization request of a terminal which uses an Instant Messaging (IM) service, the apparatus comprising:
an IM framework configured, during IM communication with another terminal, to receive from the other terminal an IM message which comprises Synchronization Markup Language (SyncML) request data to request to synchronize data, and extract the SyncML request data from the received IM message; and
a SyncML framework configured to process the corresponding data synchronization based on the extracted SyncML request data.

22. The apparatus of claim 21, wherein the SyncML framework is configured to generate SyncML response data which comprises process result information of the corresponding data synchronization, and
the IM framework is configured to insert the generated SyncML response data to an IM message and send the IM message to the other terminal.

23. The apparatus of claim 21, wherein the IM framework is configured to receive from the other terminal, an IM message which comprises SyncML start data to inform of a transmission start of the SyncML request data, extract the SyncML start data from the received IM message, provide the SyncML start data to the SyncML framework, insert the SyncML response data generated by the SyncML framework to an IM message, and send the IM message to the other terminal, and
the SyncML framework is configured to determine, based on the extracted SyncML start data, whether it is possible to synchronize the corresponding data, and generate the SyncML response data which comprises information of whether the corresponding data synchronization is possible.

24. The apparatus of claim 21, wherein the SyncML request data comprises at least one of information relating to the data to synchronize and an instruction to synchronize the corresponding data.

25. The apparatus of claim 21, wherein the SyncML framework processes the corresponding data synchronization in conjunction with a database.

26. The apparatus of claim 21, wherein the IM framework is configured to receive from the other terminal, an IM message which comprises SyncML end data to inform of a transmission end of the SyncML request data, and extract the SyncML end data from the received IM message.
